(19) United States
(12) Patent Application Publication
(10) Pub. No.: US 2014/0356627 A1
(43) Pub. Date: Dec. 4, 2014

(54) BROOKITE-FORM TITANIUM OXIDE POWDER AND METHOD FOR PRODUCING THEREOF

(71) Applicant: TOAGOSEI CO., LTD., Minato-ku, Tokyo (JP)

(72) Inventor: Koji Sugiura, Nagoya-shi (JP)

(21) Appl. No.: 14/368,915

(22) PCT Filed: Nov. 29, 2012
(86) PCT No.: PCT/JP2012/080943

§ 371 Date: Jun. 26, 2014

(30) Foreign Application Priority Data
Dec. 27, 2011 (JP) 2011-286067

(51) Int. Cl. C01G 23/047

(52) U.S. Cl. CPC C01G 23/047; C01P 2002/30; C01P 2004/51; C01P 2006/80
USPC 428/402; 423/610; 423/615

(57) ABSTRACT

A brookite-form crystalline titanium oxide powder has a volume-standard median diameter in the range of 0.3 to 40 μm as measured by a laser diffraction particle size distribution meter, and contains a brookite-form crystal in an amount of 90% by mass or more as measured by a powder X-ray diffraction method. A method for producing a brookite-form crystalline titanium oxide powder comprises a preparation step of preparing a crystalline titanium oxyoxalate powder, and a heating step of heating the crystalline titanium oxyoxalate powder at a temperature of 550° C. to 820° C.

### TECHNICAL FIELD

The present invention relates to a brookite-form titanium oxide powder and a method for producing thereof. By the method of the present invention, a high-purity brookite-form titanium oxide powder can be extremely easily obtained. Further, from the brookite-form titanium oxide obtained in the present invention, a powder in a solid form having high purity can be obtained, and therefore the brookite-form titanium oxide can be preferably used in various applications.

### BACKGROUND ART

Titanium dioxide is naturally produced in the form of rutile, anatase, and brookite minerals. Of these, rutile mainly constitutes an ore deposit, and is used as a raw material for metallic titanium. Anatase is general but scatteringly present, and brookite is a rare mineral. These natural minerals have problems in that they contain niobium or tantalum and that they have poor uniformity in the particle size. Therefore, the all titanium dioxide commercially used is a synthetic material, which is obtained by a method in which a titanium-containing ore, such as ilmenite, is dissolved in sulfuric acid and further hydrolyzed, and the resultant titanium hydroxide is heated to 500° C. or higher to obtain titanium dioxide as rutile or anatase. Such titanium dioxide is mainly used as a pigment for paint and a cosmetic, and a filler for a rubber, paper, and a synthetic resin. Further, titanium dioxide has an ultraviolet light absorbing property and hence, in recent years, the photocatalytic function of titanium dioxide has attracted attention, and titanium dioxide is incorporated into window glass, a mirror, an interior or exterior tile, and the like. Brookite has a high refractive index close to that of rutile, and has high whiteness and can protect an ultraviolet light, and has photocatalytic properties. Therefore, the utilization of brookite in the industrial fields of a cosmetic, paint, a photocatalyst, and the like is highly expected.

However, almost no production method which can stably produce brookite-form titanium oxide of a single phase has been known, and industrial production of brookite-form titanium oxide has not been performed. As a method for producing brookite-form titanium oxide, for example, Patent Document 1 discloses a method in which amorphous titanium dioxide is added to an aqueous solution of sodium hydroxide so that the Na₂O/(Na₂O+TiO₂) molar ratio becomes 0.15 to 0.45 and the TiO₂ concentration becomes 140 g/L, and the mixture is subjected to hydrothermal treatment at a temperature of 150° C. to 300° C. to produce brookite-form titanium oxide.

Further, Patent Document 2 proposes a method for producing titanium dioxide fine particles containing a brookite-form crystal, which method comprises the steps of: hydrolyzing a titanium compound to prepare an orthotitanic acid sol or gel; adding aqueous hydrogen peroxide to the sol or gel to effect peptization, and then subjecting the resultant mixture to deionization for cations and/or anions other than titanium to prepare a peroxotitanic acid solution having an ion concentration of 100 ppm or less; and adding an organic base and/or ammonia to the peroxotitanic acid solution and, while maintaining the pH in the range of from 8 to 14, subjecting the resultant mixture to hydrothermal treatment in the temperature range of from 120° C. to 350° C.

Patent Document 3 proposes a method for producing brookite-form titanium dioxide, in which an anatase-form titanium oxide powder is milled by means of a ball mill having an acceleration more than the acceleration applied to a grinding medium colliding with the sample so that the weight ratio of the grinding medium and the powder is in the range of from 10:1 to 100:1 for 0.1 to 100 hours.

Further, Patent Document 4 proposes a method for producing brookite-form titanium dioxide, characterized in that an aqueous solution containing a titanium hydroxycarbonate complex is subjected to hydrothermal treatment in the temperature range of from 100° C. to 300° C. while maintaining the pH of the aqueous solution at 8 to 13, and there is a description showing that nanoparticles having an average particle diameter of 5 to 300 nm can be obtained.

### PRIOR ART DOCUMENTS

### Patent Documents

Patent Document 1: JP-A-2000-95521 (JP-A denotes a Japanese unexamined patent application publication)

Patent Document 2: JP-A-2000-335919

Patent Document 3: JP-A-2002-316820

Patent Document 4: JP-A-2007-246301

### SUMMARY OF THE INVENTION

### Problems to be Solved by the Invention

Patent Document 1 discloses that it is possible to check whether or not a mixed crystal is present by a powder X-ray diffraction method, and that the disclosed brookite-form titanium oxide is of a single phase and contains no mixed crystal. However, Patent Document 1 does not disclose about the particle diameter of the obtained product, and merely discloses that the obtained product can be ground if necessary.

Patent Document 2 discloses that the brookite-form titanium oxide obtained by a conventionally known method in which an aqueous alkaline solution is heated has a particle diameter as large as 100 μm or more and is not uniform in the particle diameter, and thus is unsatisfactory in the dispersibility into a dispersing medium, transparency, film forming properties, adhesion, film hardness, wear resistance, and the like, and, on the other hand, by the method disclosed in Patent Document 2, particulate titanium oxide having an average particle diameter of 1 to 600 nm can be obtained. However, Patent Document 2 does not disclose that brookite-form titanium oxide of a single phase is obtained, and the brookite-form titanium oxide shown in Examples of Patent Document 2 is of a mixed crystal in a content of 5 to 60%.

In other words, particulate brookite-form titanium oxide of a single phase having an average particle diameter of 0.3 to 100 μm has not been known, and a method for producing such fine particles also has not been known. Further, in the above-mentioned two methods, a hydrothermal reaction which is conducted in an alkaline liquid phase under a pressure at a temperature of the boiling point or higher is essential, and these methods not only are dangerous but also are costly methods for the industrial practice, and thus are not an inexpensive process for mass production.

In addition, the method disclosed in Patent Document 3 is not industrially easy, and further the brookite crystal obtained by this method is not satisfactory in the crystallizability, and thus this method is not satisfactory as a method for obtaining particulate brookite-form titanium oxide of a single phase.

Further, in Examples of Patent Document 4, there is a description showing that single-phase particulate brookite-form titanium oxide having an average particle diameter of 100 nm was obtained; however, there is no description showing that brookite-form titanium oxide having another particle diameter was obtained. Furthermore, there is a description that, in the method, the “hydrothermal treatment” is essential, and further it is necessary to use a large amount of ammonia, and the like, and thus this method is not industrially easy.

It is an object of the present invention is to provide a high-purity, particulate brookite-form crystalline titanium oxide powder and a method for producing thereof, which can be industrially easily obtained.

### Means for Solving the Problems

The present inventor has conducted extensive and intensive studies with a view toward solving the above-mentioned problems. As a result, it has been found that, by heating titanium oxyoxalate, a brookite-form crystalline titanium oxide powder having high purity can be easily obtained, and the present invention has been completed. Specifically, the present invention is directed to a high-purity brookite-form crystalline titanium oxide powder using titanium oxyoxalate as a raw material and a method for producing thereof.

### BRIEF DESCRIPTION OF DRAWINGS

FIG. 1: FIG. 1 is an X-ray diffraction pattern of the brookite-form crystalline titanium oxide powder obtained in Example 1, as measured by a powder X-ray diffractometer.

FIG. 2: FIG. 2 is an X-ray diffraction pattern of the brookite-form crystalline titanium oxide powder obtained in Example 2, as measured by a powder X-ray diffractometer.

FIG. 3: FIG. 3 is an X-ray diffraction pattern of the brookite-form crystalline titanium oxide powder obtained in Example 3, as measured by a powder X-ray diffractometer.

FIG. 4: FIG. 4 is an X-ray diffraction pattern of the poorly crystalline titanium oxide powder obtained in Comparative Example 1, as measured by a powder X-ray diffractometer.

FIG. 5: FIG. 5 is an X-ray diffraction pattern of the brookite-form titanium oxide powder containing rutile-form titanium oxide obtained in Comparative Example 2, as measured by a powder X-ray diffractometer.

FIG. 6: FIG. 6 is an X-ray diffraction pattern of the powder having both the rutile-form titanium oxide and anatase-form titanium oxide present therein obtained in Comparative Example 3, as measured by a powder X-ray diffractometer.

FIG. 7: FIG. 7 is an X-ray diffraction pattern of the rutile-form titanium oxide powder obtained in Comparative Example 4, as measured by a powder X-ray diffractometer.

FIG. 8: FIG. 8 is an X-ray diffraction pattern of the anatase-form titanium oxide powder obtained in Comparative Example 5, as measured by a powder X-ray diffractometer.

FIG. 9: FIG. 9 is a scanning electron microscope photomicrograph of the brookite-form crystalline titanium oxide powder obtained in Example 1.

### EXPLANATION OF REFERENCE NUMERALS AND SYMBOLS

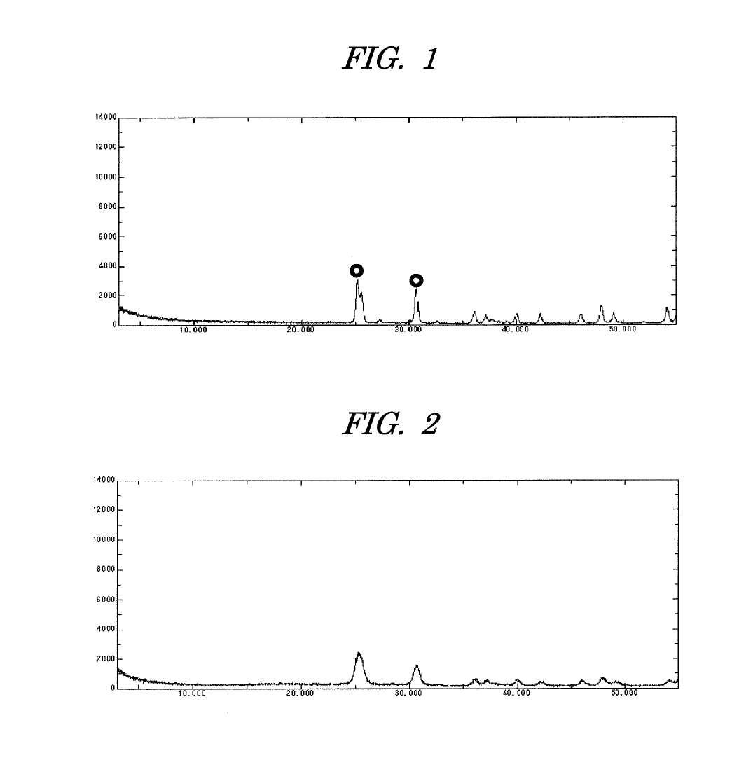

In FIGS. 1 to 8, the ordinate denotes an X-ray diffraction intensity (unit: cps) in the powder X-ray diffraction measurement.

In FIGS. 1 to 8, the abscissa denotes an X-ray diffraction angle 2θ (unit: °).

### MODE FOR CARRYING OUT THE INVENTION

The present invention will be described below. “%” denotes “% by mass” unless otherwise specified.

In the present invention, with respect to the expression indicating the range of values, the expression “the lower limit to the upper limit” means “the lower limit or more and the upper limit or less”, and the expression “the upper limit to the lower limit” means “the upper limit or less and the lower limit or more”. That is, both the expressions indicate the range of values including the upper limit and the lower limit. Further, in the present invention, “% by mass” and “% by weight” have the same meaning, and “part(s) by mass” and “part(s) by weight” have the same meaning.

The brookite-form crystalline titanium oxide powder of the present invention (hereinafter, frequently referred to simply as “brookite-form titanium oxide powder” or “brookite-form titanium oxide”) is titanium dioxide having a crystal structure of brookite-form titanium oxide exhibiting the powder X-ray diffraction pattern shown in ASTM File No. 29-1360. Representative and specific lattice plane spacing d values for representing the crystal structure are 3.51 (100), 2.90 (90), 3.47 (80), 1.89 (30), 1.66 (30), 2.48 (30), 1.69 (20), and 2.41 (20), wherein the figures in parentheses indicate a ratio relative to the X-ray diffraction intensity of the largest peak for a d value of 3.51, which is taken as 100. It is well known that the d value and diffraction angle θ has the relationship: 2d Sin θ=nλ, and λ of a CuKα ray generally used in the measurement is 1.5418 angstrom. Therefore, in the diffraction wherein n=1, the strongest diffraction peak of the brookite-form titanium oxide crystal appears at a diffraction angle 2θ=25.37° corresponding to a d value of 3.51 (100). Further, the second strongest diffraction peak of the brookite-form titanium oxide crystal is a peak appearing at a diffraction angle 2θ=30.83° corresponding to a d value of 2.90 (90), and no strong diffraction peak appears around a d value of 2.90 in the anatase and rutile. Therefore, when the measurement is made using a CuKα ray, the formation of a brookite-form titanium oxide crystal can be confirmed by the intensity of the peak appearing at a diffraction angle 2θ=30.83° without an influence of the anatase or rutile. The X-ray diffraction intensity cps at a diffraction angle 2θ=30.83, in terms of the absolute value, as measured using a CuKα ray at 40 kV/150 mA which is a common measurement condition, is preferably 500 cps or more, more preferably 1,000 cps or more, further preferably 2,000 cps or more. Further, the X-ray diffraction intensity in terms of the absolute value is preferably 100,000 cps or less. In the present invention, the purity of the brookite-form titanium oxide powder can be confirmed by a powder X-ray diffraction pattern and an impurity content. In the powder X-ray diffraction pattern, the intensity of peaks other than the peaks ascribed to the brookite-form titanium oxide powder is preferably 0 to 10% of the X-ray diffraction intensity of the largest peak for a d value of 3.51, more preferably 0 to 5%, further preferably 0%, namely, no peak other than the peaks ascribed to the brookite-form titanium oxide powder is observed.

With respect to the purity (% by mass) of the brookite-form titanium oxide crystal, a standard reference material having 100% of a brookite-form titanium oxide crystal is not provided on the market, and therefore an analysis for the purity by a standard addition method or the like is difficult. Therefore, in the present invention, from the result of powder X-ray diffraction measurement, the X-ray diffraction intensity ascribed to the brookite-form titanium oxide crystal and the X-ray diffraction intensity of the rutile, anatase, titanium oxyoxalate as a raw material, and the like are individually obtained, and the ratio of these X-ray diffraction intensities is directly converted to a mass ratio, which is defined as a purity (% by mass) wherein the whole crystal component is taken as 100%.

In the powder X-ray diffraction pattern, the X-ray diffraction intensity for a d value of 3.51, which is a diffraction peak characteristic of the brookite-form titanium oxide powder, in terms of an X-ray diffraction intensity cps as measured using a CuKα ray at 40 kv/150 mA which is a normal measurement condition, is preferably 200 cps or more, further preferably 500 cps or more. Further, the X-ray diffraction intensity is preferably 100,000 cps or less. When the X-ray diffraction intensity for a d value of 3.51 as measured under the above measurement condition is 200 cps or more, there is very few contamination of an amorphous substance or another product, and the brookite-form titanium oxide powder has high purity.

The particle diameter of the brookite-form titanium oxide powder of the present invention is based on a general laser diffraction particle size distribution meter, and a median diameter determined by calculation in terms of the volume can be defined as a representative particle diameter of the powder. The particle diameter of the brookite-form titanium oxide powder of the present invention, in terms of a median diameter, is preferably 0.3 to 40 μm, more preferably 0.5 to 40 μm, yet more preferably 1.5 to 25 μm. With respect to the shape of the brookite-form titanium oxide powder of the present invention, there is no limitation, but, by using the production method of the present invention, a powder having a spherical shape can be produced.

The brookite-form titanium oxide crystal powder of the present invention preferably has a spherical shape. It is difficult to control the shape of the powder so that the powder has a completely spherical shape, and the spherical shape includes a “substantially spherical shape” which is a spherical shape being slightly flattened or having a slightly uneven surface as observed by means of a SEM. By a method other than the below-described method of the present invention, a spherical shape is difficult to obtain, and a shape of an ellipsoid, a cylinder, a torus, a crushed form, an indefinite form, or the like is obtained. These shapes can be clearly seen by an observation by means of a scanning electron microscope (SEM), but, in the present invention, the spherical shape is defined as a shape that is seen circular as viewed in any direction, specifically, defined as follows. The length of a line connecting an arbitrary point a to another point b on the surface of a particle is taken as x. A line connecting the point a to the point b at which x is maximum is defined as the major axis of the particle, and a line connecting the point a to the point b at which x is minimum is defined as the short axis of the particle. The spherical shape means that, in a group of particles, the particles in which the length ratio of the short axis of the particle to the major axis of the particle is in the range of from 0.5 to 1 constitute 60 to 100% of the whole particles. A shape of particle in which the ratio of the short axis of the particle to the major axis of the particle is more than 0 to less than 0.5 is defined as an ellipsoid, and a shape of particle having, on the edge face of the major axis of the particle, a planar region which is 3 to 97% by area of the surface area is defined as a cylinder.

The method for producing a brookite-form crystalline titanium oxide powder of the present invention comprises a preparation step of preparing a crystalline titanium oxyoxalate powder (hereinafter, frequently referred to simply as “titanium oxyoxalate”, “titanium oxyoxalate crystal”, or “titanium oxyoxalate powder”), and a heating step of heating the crystalline titanium oxyoxalate powder at a temperature of 550 to 820° C.

By the method for producing a brookite-form crystalline titanium oxide powder of the present invention, the brookite-form crystalline titanium oxide powder of the present invention can be easily produced.

With respect to the crystalline titanium oxyoxalate used in the method of the present invention, there is no limitation, but, for removing an adverse effect on the quality of the brookite-form titanium oxide obtained after heating the crystalline titanium oxyoxalate, the crystalline titanium oxyoxalate preferably has controlled a purity or particle size. The powder X-ray diffraction pattern of the titanium oxyoxalate crystal used in the present invention is shown in ASTM File No. 48-1164, and d values are 3.35 (100), 4.62 (90), 3.22 (78), 6.48 (65), 4.24 (62), 2.84 (45), 1.88 (44), 2.59 (36), 4.18 (26), and 7.76 (24). In the powder X-ray diffraction pattern, the X-ray diffraction peak for a d value of 3.35, which is a diffraction peak characteristic of the titanium oxyoxalate powder, appears at a diffraction angle 2θ=26.57°, as measured using a CuKα ray at 40 kv/150 mA which is a normal measurement condition. With respect to the X-ray diffraction intensity cps, the X-ray diffraction intensity for a d value of 3.35 is preferably 3,000 cps or more, and, in the present invention, the titanium oxyoxalate exhibiting such a diffraction intensity is called crystalline titanium oxyoxalate, and is a preferred raw material in the production method of the present invention. The X-ray diffraction intensity is more preferably 4,000 cps or more. Further, the X-ray diffraction intensity is preferably 100,000 cps or less. When a titanium oxide crystal is mixed into the titanium oxyoxalate crystal as a raw material, the titanium oxyoxalate crystal becomes poor in chemical reactivity. Therefore, the X-ray intensity for the titanium oxide crystal is preferably 20 cps or less.

In the preparation step, the crystalline titanium oxyoxalate may be prepared by a general method. For example, the crystalline titanium oxyoxalate can be prepared by a method in which an aqueous solution of oxalic acid at 0.1 to 5 mol/L is mixed into an aqueous solution of titanyl oxysulfate at a concentration of 1 mol/L to obtain deposits of titanium oxyoxalate. The order of mixing oxalic acid and titanyl oxysulfate is not limited, and an aqueous titanyl oxysulfate solution may be dropwise added to an aqueous oxalic acid solution, an aqueous oxalic acid solution may be dropwise added to an aqueous titanyl oxysulfate solution, or these aqueous solutions may be dropwise added to water at the same time. With respect to the time for the dropwise addition and the temperature for the dropwise addition, there is no particular limitation. The temperature for the dropwise addition is preferably 100° C. or less, more preferably 1° C. to 80° C. from the viewpoint of achieving excellent workability or preferably controlling the particle diameter.

As a raw material for the crystalline titanium oxyoxalate, from the viewpoint of easy availability and inexpensiveness, and facilitating the formation of the crystalline titanium oxyoxalate, titanyl oxysulfate is preferably used.

Further, in the production method of the present invention, it is preferred that the preparation step comprises a step of mixing at least oxalic acid and titanyl oxysulfate, and it is more preferred that the provision step comprises a step of mixing oxalic acid and titanyl oxysulfate, and a step of heating the mixture containing at least oxalic acid and titanyl oxysulfate for maturing.

The heating for maturing after mixing together the raw materials facilitates crystallization of titanium oxyoxalate, and the temperature for maturing is preferably 50° C. to 100° C. With respect to the maturing time, there is no particular limitation, but the maturing time is preferably 0.5 to 48 hours, more preferably 1 to 20 hours. The resultant titanium oxyoxalate suspension is preferably washed with deionized water by, e.g., a method using a ceramic filter or repeating washing and filtration until the electrical conductance of the filtrate becomes 0 to 500 μS (siemens), thus removing impurities.

The particle diameter of the titanium oxyoxalate used in the production method of the present invention is based on a general laser diffraction particle size distribution meter, and a median diameter determined by calculation in terms of the volume can be defined as a representative particle diameter of the powder. The particle diameter of the titanium oxyoxalate, in terms of a median diameter, is preferably 0.1 to 40 μm, more preferably 0.3 to 30 μm, yet more preferably 1.5 to 25 μm.

The preferred brookite-form titanium oxide powder in the present invention preferably has a sulfur atom content (hereinafter, also referred to as “sulfur content”) of 0.05 to 1.5% by mass. It is known that a titanium oxide powder is generally synthesized from a sulfate as a raw material for a titanium compound, and general titanium oxide contains sulfur in an amount of 2% by mass or more as sulfur atoms derived from the sulfate. It is difficult to reduce the sulfur content, but the heating treatment in the production method of the present invention can reduce the sulfur content, and heating at 600° C. or higher can reduce the sulfur content to 1.5% by mass or less. The sulfur content is more preferably 1.0 to 0.07% by mass, and yet more preferably 0.7 to 0.09% by mass. By increasing the heating temperature, the sulfur content can be further reduced, but too high a temperature disadvantageously causes transition of the brookite-form titanium oxide to a rutile-form crystal. Therefore, the heating temperature in the heating step is preferably 600° C. to 810° C., more preferably 650° C. to 810° C., yet more preferably 730° C. to 810° C. The heating time in the heating step, excluding the temperature elevation time and temperature decrease time, is preferably 0.5 to 48 hours, more preferably 1 to 20 hours.

In the production method of the present invention, with respect to a heating oven used for heating the titanium oxyoxalate, there is no limitation, and an electric furnace, a gas oven, or the like can be used. Saggars are filled with the titanium oxyoxalate and stacked on one another and fired, or a rotary oven, such as a rotary kiln, can also be used. The temperature elevation rate at which a temperature is elevated to the heating temperature is preferably larger because brookite-form titanium oxide having high purity can be obtained. However, when too large a temperature elevation rate is achieved using an industrial heating apparatus, the cost is increased, and further there is a danger that the apparatus deteriorates very soon. Therefore, the temperature elevation rate is preferably from 10° C./hour to 300° C./hour. The temperature decrease rate after the heating treatment is preferably larger because brookite-form titanium oxide having high purity can be obtained. The temperature decrease rate is preferably from 10° C./hour to 300° C./hour. When the temperature is decreased by air cooling, it is difficult to keep the temperature decrease rate constant, and therefore the temperature decrease rate may vary during the decreasing of the temperature.

Further, the production method of the present invention may comprise a known step in addition to the above-described steps.

Examples of such steps include a step of washing the obtained brookite-form crystalline titanium oxide powder, and a step of drying the obtained brookite-form crystalline titanium oxide powder or the washed brookite-form crystalline titanium oxide powder.

Further, when part of the particles of the brookite-form crystalline titanium oxide obtained after the above-mentioned heating step or drying step stick to each other to form secondary particles, the production method of the present invention may comprise a step of grinding the resultant brookite-form crystalline titanium oxide to obtain a brookite-form crystalline titanium oxide powder.

With respect to the form of the use of the brookite-form titanium oxide powder of the present invention, there is no particular limitation, and the brookite-form titanium oxide powder can be mixed with appropriate another component according to the application, or a composite of the brookite-form titanium oxide powder and another material can be formed. For example, the brookite-form titanium oxide powder can be used in various forms, such as a powder, a powder-containing dispersion, powder-containing particles, powder-containing paint, powder-containing fibers, powder-containing paper, a powder-containing plastic, a powder-containing film, and a powder-containing aerosol. When the brookite-form titanium oxide powder is mixed with another component, or a composite of the brookite-form titanium oxide powder and another material is formed, the particle diameter of the brookite-form titanium oxide powder is preferably within the preferred range in the present invention because aggregation is suppressed and the dispersibility is improved. The particle shape of the powder is preferably spherical because the dispersibility is further improved. In the application involving the step of performing molding using a mold, when the particle shape of the powder is spherical, there is an effect that can be suppressed to damage the mold by the powder.

In the brookite-form titanium oxide powder of the present invention, for improving the incorporation properties into a resin or other physical properties, if necessary, various additives can be mixed. Specific examples of additives include pigments, such as zinc oxide and titanium oxide, inorganic ion-exchangers, such as zirconium phosphate and zeolite, a dye, an antioxidant, a light stabilizer, a flame retardant, an antistatic agent, a foaming agent, an impact strength modifier, glass fibers, a lubricant, such as a metallic soap, a moistureproof agent, an extender, a coupling agent, a nucleating agent, a fluidity-improving agent, a deodorant, a woodmeal, a mildewproofing agent, a stainproofing agent, a rust preventive agent, a metallic powder, an ultraviolet light absorber, an ultraviolet light screening agent, and an antiallergen agent.

By incorporating the brookite-form crystalline titanium oxide powder of the present invention into a resin, a photocatalytic resin composition can be easily obtained. With respect to the type of a resin that can be used, there is no particular limitation, and the resin may be any of a natural resin, a synthetic resin, and a semisynthetic resin, and further may be any of a thermoplastic resin and a thermosetting resin. Specifically, the resin may be any of a resin for molding, a resin for fibers, and a rubber resin, and examples of resins include resins for molding or for fibers, such as polyethylene, polypropylene, polyvinyl chloride, an acrylonitrile-butadiene-styrene (ABS) resin, an acrylonitrile-styrene (AS) resin, a methyl methacrylate-butadiene-styrene (MBS) resin, a nylon resin, polyester, polyvinylidene chloride, polystyrene, polyacetal, polycarbonate, polybutylene terephthalate (PBT), an acrylic resin, a fluoropolymer, a polyurethane elastomer, a polyester elastomer, a melamine, an urea resin, an ethylene tetrafluoride resin, an unsaturated polyester resin, rayon, acetate, acryl, polyvinyl alcohol, cuprammonium rayon, triacetate, and vinylidene, and rubber resins, such as a natural rubber, a silicone rubber, a styrene-butadiene rubber, an ethylene-propylene rubber, a fluororubber, a nitrile rubber, a chlorosulfonated polyethylene rubber, a butadiene rubber, a synthetic natural rubber, a butyl rubber, an urethane rubber, and an acrylic rubber. Further, the brookite-form crystalline titanium oxide powder of the present invention and natural fibers can together form a composite to produce photocatalytic fibers.

The amount of the brookite-form crystalline titanium oxide powder of the present invention incorporated into the photocatalytic resin composition is, relative to 100 parts by weight of the photocatalytic resin composition, preferably 0.1 to 50 parts by weight, more preferably 0.5 to 20 parts by weight. When the amount of the brookite-form crystalline titanium oxide powder is 0.1 part by weight or more, the resultant photocatalytic resin composition exhibits satisfactory photocatalytic properties. On the other hand, when the amount of the brookite-form crystalline titanium oxide powder is 50 parts by weight or less, the resultant photocatalytic resin composition exhibits excellent physical properties of resin.

As a method of incorporating the brookite-form crystalline titanium oxide powder of the present invention into a resin to form a resin shaped article, any of known methods can be employed. Examples of such methods include (1) a method in which, using a binder for facilitating the adhesion between the brookite-form titanium oxide powder and a resin or a dispersant for improving the dispersibility of the brookite-form titanium oxide powder, a resin in a pellet form or a resin in a powdery form is directly mixed with the brookite-form titanium oxide powder by means of a mixer, (2) a method in which the mixture obtained as mentioned above is shaped into pellets by means of an extruder, and then the resultant shaped material is incorporated into a resin in a pellet form, (3) a method in which brookite-form titanium oxide is shaped into high-concentration pellets using a wax, and then the resultant shaped material in a pellet form is incorporated into a resin in a pellet form, and (4) a method in which brookite-form titanium oxide is dispersed and mixed into a high-viscosity liquid material, such as a polyol, to prepare a composition in a paste form, and then the prepared paste is incorporated into a resin in a pellet form.

In the above-mentioned shaping of the photocatalytic resin composition, according to the properties of various resins, any known processing techniques and machines can be used, and a resin shaped article can be easily prepared by a method of mixing, incorporation, or kneading while heating at an appropriate temperature and pressurizing at an appropriate pressure or under a reduced pressure. The specific operation for shaping may be performed in accordance with a general method, and the photocatalytic resin composition can be shaped into various forms, such as a bulk form, a sponge form, a film form, a sheet form, a thread form, a pipe form, and a composite thereof.

With respect to the form of the use of the brookite-form crystalline titanium oxide powder of the present invention, there is no particular limitation, and the form of the use is not limited to the incorporation into a resin shaped article or a polymer compound. The brookite-form crystalline titanium oxide powder can be mixed with appropriate another component according to the application which needs photocatalytic properties, or a composite of the brookite-form crystalline titanium oxide powder and another material can be formed. For example, the brookite-form crystalline titanium oxide powder can be used in various forms, such as a powdery form, a powder dispersion form, a particulate form, an aerosol form, and a liquid form.

The brookite-form crystalline titanium oxide powder of the present invention has the photocatalytic ability, and therefore can be used in various fields that require deodorizing properties, mildewproofing properties, algaproofing properties, and antifungal properties, specifically, in electrical appliances, kitchen products, fiber products, house building materials, toiletry products, paper products, toys, leather products, stationery, and other products.

Further, specific examples of the applications are shown below. Examples of electrical appliances include a dish washer, a dish dryer, a refrigerator, a washing machine, an electric kettle, a television, a personal computer, a radio cassette recorder, a camera, a camcorder, a water purifier, a rice cooker, a vegetable cutter, a cash register, a bedclothes dryer, a FAX, a ventilator, and an air conditioner. Examples of kitchen products include tableware, a cutting board, a straw cutter, a tray, chopsticks, a tea server, a thermos bottle, a kitchen knife, a handle of a ladle, a spatula, a lunch box, a rice scoop, a bowl, a colander, a sink-corner strainer, a scrub brush receiver, a dust box, and a draining bag.

Examples of fiber products include a shower curtain, wadding for bedclothes, a filter for air conditioner, pantyhose, socks, a wet towel, a sheet, a bedclothes cover, a pillow, gloves, an apron, a curtain, a diaper, a bandage, a mask, and a sportswear. Examples of house building materials include a decorative laminated sheet, wallpaper, a floor board, a film for window, a knob, a carpet, a mat, artificial marble, a handrail, a joint, a tile, and a wax. Examples of toiletry products include a toilet, a bathtub, a tile, a closestool, a sanitary box, a toilet brush, a bathtub cover, pumice, a soap receiver, a bath chair, a clothesbasket, a showerhead, and a sink. Examples of paper products include wrapping paper, powder paper, a medicine chest, a sketchbook, a chart for a patient, a notebook, and paper used for making figures by folding, and examples of toys include a doll, a stuffed toy, a paper clay, blocks, and a puzzle.

Further, examples of leather products include shoes, a bag, a belt, a watchband, a trim, a chair, gloves, and a hand strap, and examples of stationery include a ball-point pen, a propelling pencil, a pencil, an eraser, a crayon, a blank form, a pocket notebook, a flexible disc, a ruler, a tag, and a stapler.

Examples of other products include an insole, a cosmetic container, a scrub brush, a powder puff, a hearing aid, a musical instrument, a tobacco filter, a cleaning adhesive paper sheet, a handle of a hand strap, a sponge, a kitchen towel, a card, a microphone, barber utensils, a vending machine, a razor, a telephone, a thermometer, a stethoscope, slippers, a clothes casing, a toothbrush, sand for sandbox, a food packaging film, an anti-fungal spray, and paint.

By the present invention, a brookite-form crystalline titanium oxide powder having high purity and being highly crystalline can be obtained. Further, the method for producing a brookite-form crystalline titanium oxide powder of the present invention is simple from the viewpoint of the apparatuses, conditions, and operations and thus is an industrially easy method.

### EXAMPLES

The present invention will be described below with reference to the following Examples, which should not be construed as limiting the scope of the present invention.

A median diameter is a value measured using a laser diffraction particle size distribution meter and analyzed in terms of the volume. X-ray diffraction (XRD diffraction) was measured by means of a powder X-ray diffractometer (model RINT2400V, manufactured by Rigaku Denki K.K.) under measurement conditions at 40 kV/150 mA using a CuKα ray. A purity (% by mass) of the brookite-form titanium oxide crystal was determined as follows. In the powder X-ray diffraction pattern, the X-ray diffraction intensity of brookite-form titanium oxide crystal powder shown in ASTM File No. 29-1360 was taken as a purity component derived from the brookite-form titanium oxide crystal and, on the other hand, the X-ray diffraction intensity of X-ray diffraction peaks ascribed to the rutile, anatase, titanium oxyoxalate, and the like was taken as an impurity component. The ratio of these X-ray diffraction intensities was directly converted to a mass ratio, namely, the whole crystal component was taken as 100% and a purity (% by mass) of the brookite-form titanium oxide crystal was determined by making a calculation. A sulfur atom content was determined as follows. Using a fluorescent X-ray analyzer (model ZSX-100e, manufactured by Rigaku Denki K.K.), the amounts of titanium atoms and sulfur atoms contained were measured, and, from these amounts, a sulfur atom content of the whole titanium oxide (TiO₂) was determined by making a calculation.

### Synthesis Example 1

In a glass flask having a capacity of 1 liter, 0.25 mol of oxalic acid dihydrate was added to 250 mL of deionized water and dissolved at 30° C. An aqueous solution at 30° C., which had been obtained by dissolving 0.5 mol of titanyl oxysulfate in 250 mL of deionized water, was dropwise added to the above solution at a constant rate over 20 minutes. After completion of the dropwise addition, the mixture was stirred at 1,000 rpm at 95° C. for 6 hours. Then, the precipitate was well washed with deionized water, and dried at 120° C. for 4 hours, followed by grinding, to synthesize titanium oxyoxalate. With respect to the obtained titanium oxyoxalate, an XRD diffraction measurement was made. As a result, the resultant diffraction pattern was consistent with ASTM File No. 48-1164. The X-ray diffraction intensity for a d value of 3.35 was 9,200 cps, as measured using a CuKα ray at 40 kV/150 mA, and no diffraction peak ascribed to a substance other than titanium oxyoxalate was found. That is, crystalline titanium oxyoxalate having high purity was obtained. Then, a volume-standard median diameter was measured by means of a laser diffraction particle size distribution meter. As a result, the median diameter was 3.5 μm.

### Synthesis Example 2

50 mol of titanyl oxysulfate was added to 20 L of deionized water and dissolved at 50° C. An aqueous solution at 50° C., which had been obtained by dissolving 25 mol of oxalic acid dihydrate in 25 L of deionized water, was dropwise added to the above solution over 10 minutes. After completion of the dropwise addition, the temperature of the mixture was increased to 95° C. over 30 minutes, and further the mixture was stirred at 500 rpm for 8 hours. Then, the precipitate was well washed and dried at 120° C. for 4 hours, followed by grinding, to synthesize titanium oxyoxalate. The obtained crystalline titanium oxyoxalate had a median diameter of 14.5 μm.

### Synthesis Example 3

In a glass flask having a capacity of 1 liter, 0.25 mol of oxalic acid dihydrate was added to 250 mL of deionized water and dissolved at 30° C. An aqueous solution at 30° C., which had been obtained by dissolving 0.5 mol of titanyl oxysulfate in 250 mL of deionized water, was dropwise added to the above solution over 20 minutes. After completion of the dropwise addition, the mixture was stirred at 1,000 rpm at 95° C. for 6 hours. Then, the precipitate was well washed and dried at 120° C. for 4 hours, followed by grinding, to synthesize crystalline titanium oxyoxalate. The obtained crystalline titanium oxyoxalate had a median diameter of 1.6 μm.

### Example 1

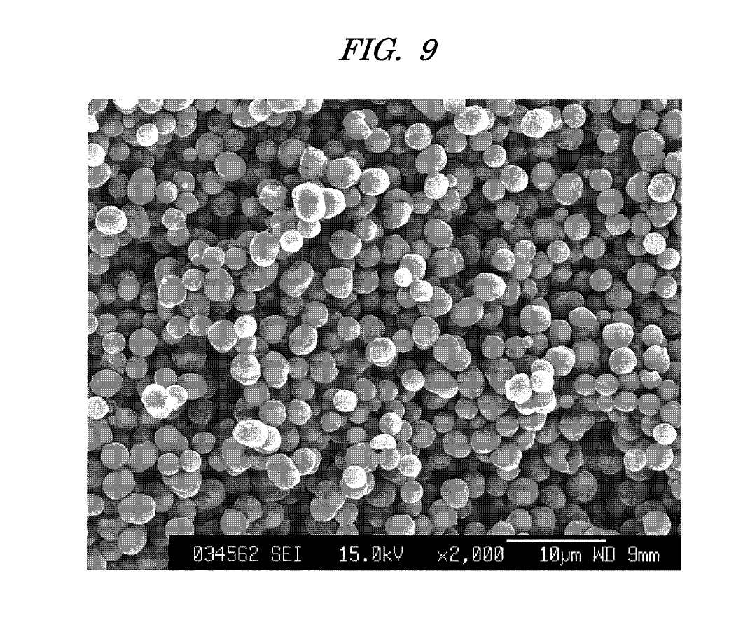

A rectangular saggar made of mullite was filled with the crystalline titanium oxyoxalate obtained in Synthesis Example 1 and placed in a horizontal electric furnace, and the temperature was increased to 710° C. at 200° C./hour, and then the titanium oxyoxalate was heated at 710° C. for 10 hours, and then allowed to stand so as to be cooled to 150° C. at 300° C./hour to 100° C./hour, followed by roughly grinding using a mortar, to obtain brookite-form titanium oxide. With respect to the obtained brookite-form titanium oxide, the results of the measurement of median diameter, purity, particle shape, and sulfur content are shown in Table 1, the results of the XRD diffraction measurement are shown in FIG. 1, and an electron photomicrograph is shown in FIG. 9. In FIG. 1, the strongest diffraction peak of the brookite-form titanium oxide crystal corresponding to a d value of 3.51 (100) appears at a diffraction angle 2θ=25.37°, and a large peak corresponding to a d value of 2.90 (90) appears at a diffraction angle 2θ=30.83°, and these peaks are indicated by symbol ◯. The other peaks are also well consistent with the standard peaks of brookite-form titanium oxide, which has confirmed that brookite-form titanium oxide of a substantially single phase was obtained.

### Example 2

A rectangular saggar made of mullite was filled with the crystalline titanium oxyoxalate obtained in Synthesis Example 2 and placed in a gas oven, and the temperature was increased to 600° C. at 200° C./hour, and then the titanium oxyoxalate was heated at 600° C. for 2 hours. The resultant material was allowed to stand so as to be cooled to 150° C. at 300° C./hour to 100° C./hour, followed by roughly grinding using a mortar. With respect to the obtained brookite-form titanium oxide, the results of the measurement of median diameter, purity, particle shape, and sulfur content are shown in Table 1, and the results of the XRD diffraction measurement are shown in FIG. 2.

### Example 3

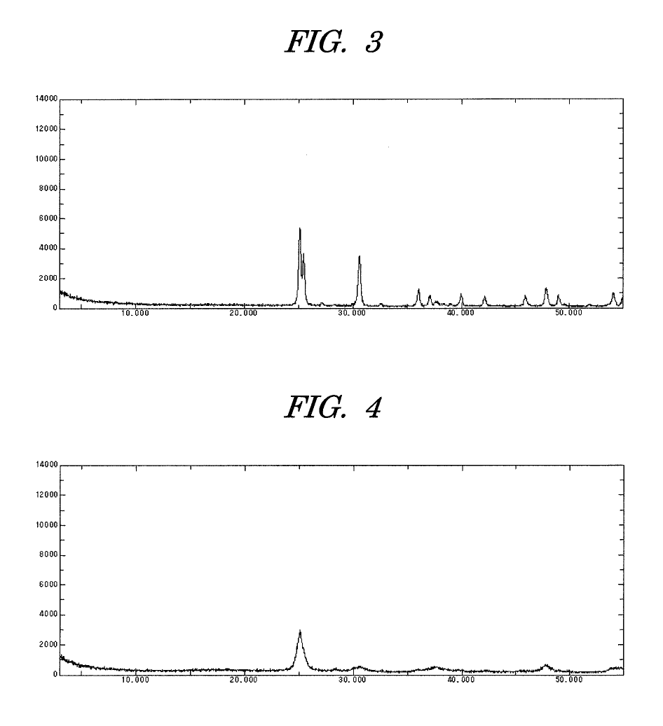

A rectangular saggar made of mullite coated with silicon carbide was filled with the crystalline titanium oxyoxalate obtained in Synthesis Example 3 and placed in a horizontal electric furnace, and the temperature was increased to 750° C. at 200° C./hour, and then the titanium oxyoxalate was heated at 750° C. for 2 hours. The resultant material was allowed to stand so as to be cooled to 150° C. at 300° C./hour to 100° C./hour, followed by roughly grinding using a mortar. With respect to the obtained brookite-form titanium oxide, the results of the measurement of median diameter, purity, particle shape, and sulfur content are shown in Table 1, and the results of the XRD diffraction measurement are shown in FIG. 3.

### Comparative Example 1

A rectangular saggar made of mullite was filled with the crystalline titanium oxyoxalate obtained in Synthesis Example 3 and placed in a horizontal electric furnace, and the temperature was increased to 530° C. at 200° C./hour, and then the titanium oxyoxalate was heated at 530° C. for 10 hours. The resultant material was allowed to stand so as to be cooled to 150° C. at 300° C./hour to 100° C./hour, followed by roughly grinding using a mortar. As a result, poorly crystalline titanium oxide was obtained. The results of the measurement of median diameter, purity, particle shape, and sulfur content are shown in Table 1, and the results of the XRD diffraction measurement are shown in FIG. 4.

### Comparative Example 2

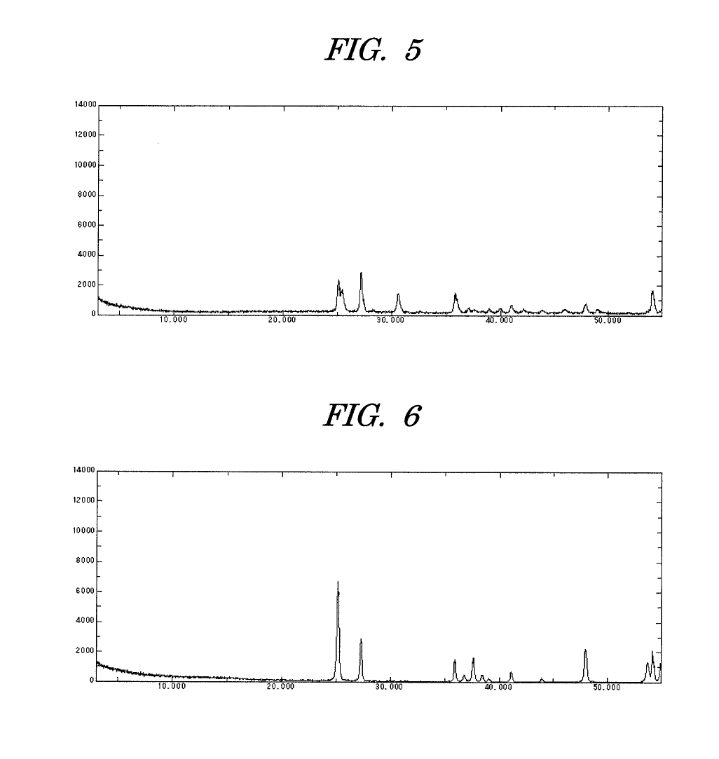

A rectangular saggar made of mullite was filled with the crystalline titanium oxyoxalate obtained in Synthesis Example 3 and placed in a horizontal electric furnace, and the temperature was increased to 830° C. at 200° C./hour, and then the titanium oxyoxalate was heated at 830° C. for 1 hour. The resultant material was allowed to stand so as to be cooled to 150° C. at 300° C./hour to 100° C./hour, followed by roughly grinding using a mortar. As a result, brookite-form titanium oxide containing a rutile-form crystal in a large amount was obtained. The results of the measurement of median diameter, purity, particle shape, and sulfur content are shown in Table 1, and the results of the XRD diffraction measurement are shown in FIG. 5.

### Comparative Example 3

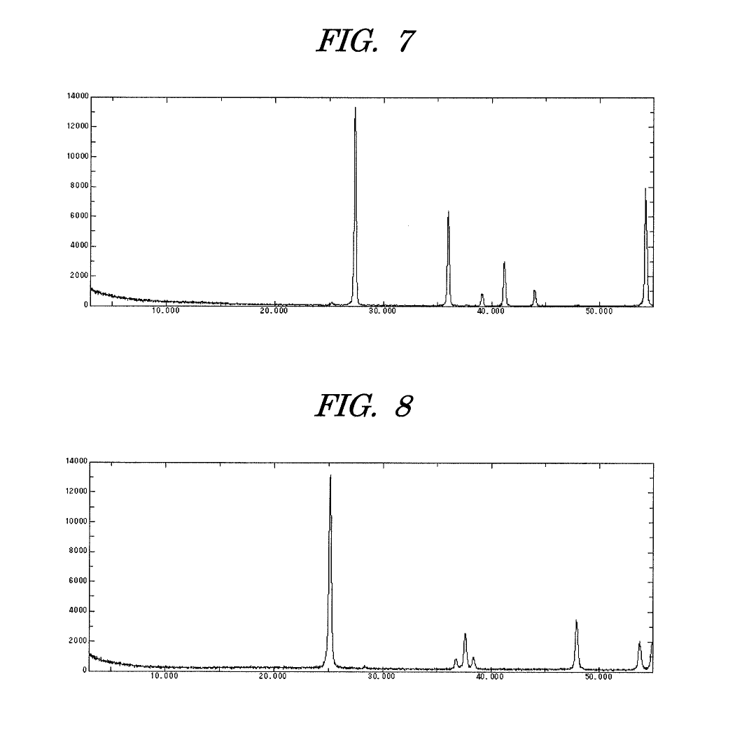

A rectangular saggar made of mullite was filled with commercially available amorphous titanium oxyoxalate and placed in a horizontal electric furnace, and the temperature was increased to 750° C. at 200° C./hour, and then the titanium oxyoxalate was heated at 750° C. for 2 hours. The resultant material was allowed to stand so as to be cooled to 150° C. at 300° C./hour to 100° C./hour, followed by roughly grinding using a mortar. As a result, anatase-form titanium oxide containing a rutile-form crystal was obtained. The results of the measurement of median diameter, purity, particle shape, and sulfur content are shown in Table 1, and the results of the XRD diffraction measurement are shown in FIG. 6.

### Comparative Example 4

A rectangular saggar made of mullite was filled with commercially available ammonium titanium oxyoxalate ((NH₄)₂[Ti(C₂O₄)₂O].nH₂O, manufactured by Mitsuwa Chemicals Co., Ltd.) and placed in a horizontal electric furnace, and the temperature was increased to 750° C. at 200° C./hour, and then the ammonium titanium oxyoxalate was heated at 750° C. for 2 hours. The resultant material was allowed to stand so as to be cooled to 150° C. at 300° C./hour to 100° C./hour, followed by roughly grinding using a mortar. As a result, rutile-form titanium oxide was obtained. The results of the measurement of median diameter, purity, particle shape, and sulfur content are shown in Table 1, and the results of the XRD diffraction measurement are shown in FIG. 7.

### Comparative Example 5

A rectangular saggar made of mullite was filled with commercially available titanium oxysulfate (TiOSO₄.nH₂O, manufactured by Mitsuwa Chemicals Co., Ltd.) and placed in a horizontal electric furnace, and the temperature was increased to 750° C. at 200° C./hour, and then the titanium oxysulfate was heated at 750° C. for 2 hours. The resultant material was allowed to stand so as to be cooled to 150° C. at 300° C./hour to 100° C./hour, followed by roughly grinding using a mortar. As a result, anatase-form titanium oxide was obtained. The results of the measurement of median diameter, purity, particle shape, and sulfur content are shown in Table 1, and the results of the XRD diffraction measurement are shown in FIG. 8.

TABLE 1

| | | | | Sulfur | |
|---|---|---|---|---|---|
| | Median | Purity | | atom | |
| | diameter | (% by | Particle | content (% | Crystal |
| | (μm) | mass) | shape | by mass) | system |
| Example 1 | 3.2 | 93 | Spherical | 0.24 | Brookite |
| Example 2 | 12.3 | 91 | Spherical | 1.33 | Brookite |
| Example 3 | 1.5 | 99 | Spherical | 0.09 | Brookite |
| | | or more | | | |
| Comparative | 2.7 | — | Spherical | 2.1 | Amorphous |
| Example 1 | | | | | |
| Comparative | 7.7 | 40 | Porous | 0.03 | Rutile |
| Example 2 | | | spherical | | Brookite |
| Comparative | 0.4 | — | Indefinite | 1.52 | Anatase |
| Example 3 | | | | | Rutile |
| Comparative | 1.2 | — | Non- | 0.14 | Rutile |
| Example 4 | | | spherical | | |
| Comparative | 1.6 | — | Non- | 0.11 | Anatase |
| Example 5 | | | spherical | | |

Examples 1 to 3 have confirmed that, by heating crystalline titanium oxyoxalate in a specific temperature range, a brookite-form titanium oxide powder having high purity can be obtained. In Comparative Examples 1, 3, 4, and 5, the diffraction peak for a d value of 3.51 of the brookite-form titanium oxide did not appear, making it impossible to determine a purity. Comparative Examples 1 to 5 have confirmed that when crystalline titanium oxyoxalate is heated at a temperature different from the temperature defined in the present invention, or when a material other than crystalline titanium oxyoxalate is heated, a brookite-form titanium oxide powder having high purity cannot be obtained.

### INDUSTRIAL APPLICABILITY

By the present invention, there can be obtained a high-purity, highly crystalline brookite-form titanium oxide powder which can be preferably used in the above-mentioned various applications. Further, the method for producing a brookite-form titanium oxide powder of the present invention is simple from the viewpoint of the apparatuses, conditions, and operations and thus is an industrially usable method.

1. (canceled)

2. (canceled)

3. A method for producing a brookite-form crystalline titanium oxide powder, comprising:
a preparation step of preparing a crystalline titanium oxyoxalate powder, and
a heating step of heating the crystalline titanium oxyoxalate powder at a temperature of 650° C. to 810° C.

4. (canceled)

5. The method for producing a brookite-form crystalline titanium oxide powder according to claim 3, wherein, in the heating step, the temperature elevation rate at which a temperature is elevated to the heating temperature is 10° C./hour to 300° C./hour.

6. The method for producing a brookite-form crystalline titanium oxide powder according to claim 3, wherein the obtained brookite-form crystalline titanium oxide powder has a volume-standard median diameter in the range of 0.3 to 40 μm as measured by a laser diffraction particle size distribution meter, and comprises a brookite-form crystal in an amount of 90% by mass or more as measured by a powder X-ray diffraction method.

7. The method for producing a brookite-form crystalline titanium oxide powder according to claim 3, wherein the obtained brookite-form crystalline titanium oxide powder has a sulfur atom content of 0.05 to 1.5% by mass.

8. The method for producing a brookite-form crystalline titanium oxide powder according to claim 3, wherein the preparation step comprises a step of mixing at least oxalic acid and titanyl oxysulfate.

9. The method for producing a brookite-form crystalline titanium oxide powder according to claim 3, wherein the preparation step comprises, in this order, a step of mixing oxalic acid and titanyl oxysulfate, and a step of heating the mixture containing at least oxalic acid and titanyl oxysulfate for maturing.

10. The method for producing a brookite-form crystalline titanium oxide powder according to claim 3, wherein the heating temperature in the heating step is 730° C. to 810° C.

11. The method for producing a brookite-form crystalline titanium oxide powder according to claim 3, wherein the obtained brookite-form crystalline titanium oxide powder has a sulfur atom content of 0.07 to 1.0% by mass.

12. The method for producing a brookite-form crystalline titanium oxide powder according to claim 8, wherein the obtained brookite-form crystalline titanium oxide powder has a sulfur atom content of 0.07 to 1.0% by mass.
